(19) United States
(12) Patent Application Publication
(10) Pub. No.: US 2009/0040419 A1
(43) Pub. Date: Feb. 12, 2009

(54) ELECTRON EMISSION DEVICE FOR BACK LIGHT UNIT AND LIQUID CRYSTAL DISPLAY USING THE SAME

(76) Inventors: Jin-seok Lee, Suwon (KR); Ji-won Lee, Suwon (KR); Duck-gu Cho, Suwon (KR)

Correspondence Address: CHRISTIE, PARKER & HALE, LLP, PO BOX 7068, PASADENA, CA, 91109-7068, US

(21) Appl. No.: 12/116,532

(22) Filed: May 7, 2008

(30) Foreign Application Priority Data
Aug. 8, 2007 (KR) 10-2007-0079524

(51) Int. Cl. G09G 3/20; H01J 1/62; G02F 1/1335; G09G 3/36

(52) U.S. Cl. 349/61; 313/496; 345/102; 345/75.1

(57) ABSTRACT

An electron emission display device is provided having a light source unit including a plurality of cathode electrodes and a plurality of gate electrodes crossing the plurality of cathode electrodes. The light source unit emits electrons corresponding to voltages of the gate electrodes and the cathode electrodes and allows the emitted electrons to collide with a phosphor on an anode electrode to emit light. A gate driver generates a gate signal and transmits the gate signal to at least one of the gate electrodes. A cathode driver generates a cathode driving signal corresponding to an image signal and transmits the cathode driving signal to the cathode electrode. The cathode driving signal is transmitted in a plurality of pulse waveforms within one vertical synchronization period.

### CROSS-REFERENCE TO RELATED APPLICATION

This application claims priority to and the benefit of Korean Patent Application No. 10-2007-0079524, filed on Aug. 8, 2007, in the Korean Intellectual Property Office, the entire content of which is incorporated herein by reference.

### BACKGROUND

1. Field of the Invention

The present invention relates to an electron emission device for a back light unit and a liquid crystal display, and more particularly to an electron emission device for a back light unit with enhanced luminous efficiency, and a liquid crystal display using the electron emission device.

2. Description of the Related Art

A flat panel display includes a plurality of pixels on a substrate in a matrix for use in a display area and includes scan lines and data lines coupled to the pixels for selectively applying a data signal to the pixels to display an image.

A flat panel display can be categorized into a passive matrix type display device or an active matrix type display device according to the driving mode of the pixels. In aspects of resolution, contrast, and operation speed, the active matrix type display device has been mainly used. The active matrix type display device can select each pixel to be turned on/off.

These flat panel displays have been used as display devices such as in portable information terminals, personal computers, mobile phones, personal digital assistants (PDAs), monitors of various information appliances, liquid crystal displays using liquid crystal panels, organic light emitting displays using organic light emitting diodes, plasma display panels (PDPs) using plasma panels, and electron emission display devices using electron emission devices. Among the flat panel displays, the electron emission display device may be used as a back light unit of a liquid crystal display.

FIG. 1 is a waveform view showing an input waveform inputted from a passive matrix-type flat panel display panel. Referring to FIG. 1, the passive matrix-type flat panel display panel displays an image for a period of one frame corresponding to a period between two successive vertical synchronizing signal (Vsync) inputs. A scan signal (Sn) is transmitted within the period of the one frame, and a data signal (Data) is transmitted to a pixel to which the scan signal (Sn) is transmitted, thereby allowing the pixels to emit light corresponding to the data signal (Data).

Pulse width modulation, which is a method of adjusting a pulse wave width of a scan signal, is used to represent grey levels. That is, the grey levels are represented according to the light emission time by lengthening a pulse width of the scan signal to represent bright grey levels and shortening a pulse width of the scan signal to represent dark grey levels.

If the above-mentioned method is used to drive an electron emission display device, the electron emission display device emits electrons corresponding to a difference of voltage between a gate electrode and a cathode electrode, and the emitted electrons collide with a phosphor film, thereby allowing the phosphor film to emit light. If a high voltage is applied to a gate electrode, a cathode electrode, and an anode electrode, and a light emission time is made longer to represent bright grey levels, then the gate electrode, the cathode electrode, and the anode electrode may be damaged due to the high voltage, and a life span of the electron emission display device is thereby shortened.

### SUMMARY OF THE INVENTION

An electron emission display device is provided that is capable of enhancing luminous efficiency by shortening a period that a signal is transmitted to a gate electrode, and of extending a life span of an emitter, by dividing a gate signal into a plurality of pulses and maintaining a predetermined voltage in the gate electrode due to the presence of a pulse falling time between a pulse and a pulse, the gate signal being transmitted during a vertical synchronization period to enhance luminous efficiency in the passive matrix-type flat panel display device, and a liquid crystal display thereof.

According to an exemplary embodiment of the present invention, an electron emission display device is provided having a light source unit including a plurality of cathode electrodes and a plurality of gate electrodes crossing the plurality of cathode electrodes. The light source unit is for emitting electrons corresponding to voltages of the gate electrodes and the cathode electrodes and allowing the emitted electrons to collide with a phosphor on an anode electrode to emit light. A gate driver is for generating a gate signal and transmitting the gate signal to at least one of the gate electrodes. A cathode driver is for generating a cathode driving signal corresponding to an image signal and transmitting the cathode driving signal to at least one of the cathode electrodes. The cathode driving signal is transmitted in a plurality of pulse waveforms within one vertical synchronization period.

In one embodiment, a voltage of the pulse waveforms is adjusted to correspond to the image signal.

In one embodiment, the light source unit is adapted to adjust grey levels of the image signal to correspond to a pulse width of the cathode driving signal.

In an exemplary embodiment of the present invention, an emission display device is provided having a light source unit including a plurality of cathode electrodes and a plurality of gate electrodes crossing the plurality of cathode electrodes. The light source unit is for emitting electrons corresponding to voltages of the gate electrodes and the cathode electrodes and allowing the emitted electrons to collide with a phosphor on an anode electrode to emit light. A gate driver is for generating a gate signal and transmitting the gate signal to at least one of the gate electrodes. A cathode driver is for generating a cathode driving signal corresponding to an image signal and transmitting the cathode driving signal to at least one of the cathode electrodes. The gate signal is transmitted in a plurality of pulse waveforms within one vertical synchronization period.

In one embodiment, a voltage of the pulse waveforms is adjusted to correspond to the image signal.

In one embodiment, the light source unit is adapted to adjust grey levels of the image signal to correspond to a pulse width of the gate signal.

In another exemplary embodiment of the present invention, a liquid crystal display is provided having a pixel unit, a data driver, a scan driver, and a back light unit. The pixel unit includes a plurality of liquid crystal cells and for displaying an image by selectively passing or suppressing light of a light source by utilizing a data signal and a scan signal. The data driver is for transmitting the data signal to the pixel unit. The scan driver is for transmitting the scan signal to the pixel unit. The back light unit is for transmitting light from the light source to the pixel unit. The back light unit includes a light source unit including a plurality of cathode electrodes and a plurality of gate electrodes crossing the plurality of cathode electrodes. The light source unit is for emitting electrons corresponding to voltages of the gate electrodes and the cathode electrodes and allowing the emitted electrons to collide with an anode electrode to emit the light. A gate is driver for generating a gate signal and transmitting the gate signal to at least one of the gate electrodes. A cathode driver is for generating a cathode driving signal corresponding to an image signal and transmitting the cathode driving signal to at least one of the cathode electrodes. The cathode driving signal is transmitted in a plurality of pulse waveforms within one vertical synchronization period.

In one embodiment, a voltage of the pulse waveforms is adjusted to correspond to the image signal.

In one embodiment, the light source unit is adapted to adjust grey levels of the image signal to correspond to a pulse width of the cathode driving signal.

In one embodiment, the cathode driving signal is transmitted during a subset of the vertical synchronization period.

In yet another exemplary embodiment of the present invention, a liquid crystal display is provided having a pixel unit, a data driver, a scan driver, and a back light unit. The pixel unit including a plurality of liquid crystal cells and for displaying an image by selectively passing or suppressing light of a light source by utilizing a data signal and a scan signal. The data driver for transmitting the data signal to the pixel unit. The scan driver for transmitting the scan signal to the pixel unit. The back light unit for transmitting light from the light source to the pixel unit. The back light unit includes a light source unit including a plurality of cathode electrodes and a plurality of gate electrodes crossing the plurality of cathode electrodes. The light source unit is for emitting electrons to correspond to voltages of the gate electrodes and the cathode electrodes and allowing the emitted electrons to collide with a phosphor on an anode electrode to emit the light. A gate driver is for generating a gate signal and transmitting the gate signal to at least one of the gate electrodes. A cathode driver is for generating a cathode driving signal corresponding to an image signal and transmitting the cathode driving signal to the cathode electrode. The gate signal is transmitted in a plurality of pulse waveforms within one vertical synchronization period.

In yet another exemplary embodiment of the present invention, a method for driving a liquid crystal display that displays an image by adjusting transmissivity of light of a light source for liquid crystal cells by utilizing a data signal and a scan signal is provided. The method includes transmitting the scan signal and the data signal to at least one of the liquid crystal cells to maintain the data signal during one frame period; and transmitting light from the light source, generated in a back light unit, in a plurality of pulse waveforms for a subset of one frame period when the at least one of the liquid crystal cells are maintained to an active level.

In one embodiment, the back light unit adjusts luminance of the light source by utilizing pulse width modulation.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a waveform view showing an input waveform inputted from a passive matrix-type flat panel display panel.

FIG. 2 is a configuration view showing a configuration of an electron emission display device according to an exemplary embodiment of the present invention.

FIG. 3 is a configuration view showing a liquid crystal display according to an exemplary embodiment of the present invention.

FIG. 4 is a waveform view showing a concept that light is emitted from the electron emission display device according to an exemplary embodiment of the present invention.

FIG. 5 is a waveform view showing a waveform of a signal inputted to the liquid crystal display according to an exemplary embodiment of the present invention.

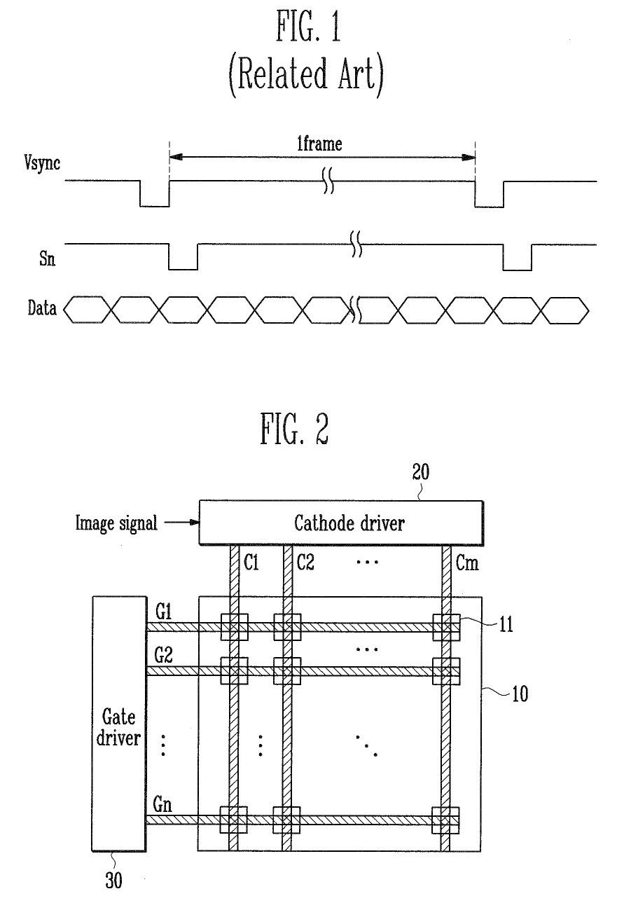

### DETAILED DESCRIPTION OF EXEMPLARY EMBODIMENTS

Hereinafter, certain exemplary embodiments according to the present invention will be described with reference to the accompanying drawings. Herein, when a first element is described as being coupled to a second element, the first element may be not only directly coupled to the second element but may also be indirectly coupled to the second element via one or more third elements. Also, like reference numerals refer to like elements throughout.

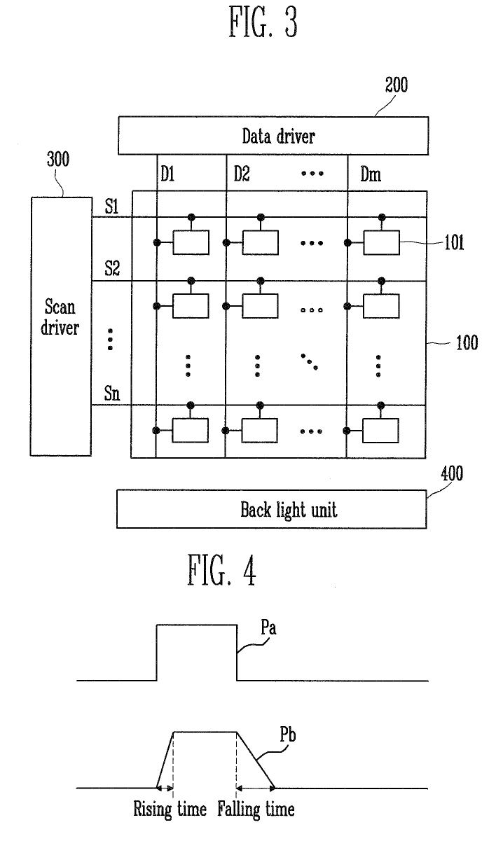

FIG. 2 is a configuration view showing a configuration of an electron emission display device according to an exemplary embodiment of the present invention. Referring to FIG. 2, the electron emission display device includes a light source unit 10, a cathode driver 20, and a gate driver 30.

The light source unit 10 has a plurality of light sources 11 formed in points where gate electrodes (G1, G2, . . . Gn) cross with cathode electrodes (C1, C2, . . . Cm), and electrons emitted from emitters coupled to the cathode electrodes (C1, C2, . . . Cm) collide with a phosphor or a fluorescent substance on an anode electrode to allow light to be emitted. The light emitting intensity is determined according to the amount of electrons emitted from the emitters and correspond to a grey level value of an image signal. The emitters contact the cathode electrode (C1, C2, . . . Cm) and emit the electrons by utilizing a voltage between the gate electrode and the cathode electrode. In one embodiment, the emitter includes carbon nano tubes (CNTs), but the present invention is not thereby limited.

The cathode driver 20 is coupled to the cathode electrodes (C1, C2 . . . Cm), and receives the image signal to generate a cathode driving signal and transmits the generated cathode driving signal to the light source unit 10.

The gate driver 30 is coupled to the gate electrodes (G1,G2 . . . Gn), and generates a gate signal and transmits the generated gate signal to the light source unit 10. The circuit cost and power consumption may be reduced by utilizing a line scan mode to display an entire image by allowing the light source unit 10 to sequentially emit light for a certain period in a horizontal line.

FIG. 3 is a configuration view showing a liquid crystal display according to an exemplary embodiment of the present invention. Referring to FIG. 3, the liquid crystal display includes a pixel unit (or display region) 100, a data driver 200, a scan driver 300, and a back light unit 400.

The pixel unit 100 has a plurality of pixels 101 formed at regions where a plurality of scan lines (S1,S2, . . . Sn) cross with a plurality of data lines (D1,D2 . . . Dm). One pixel corresponds to one liquid crystal cell, and each liquid crystal cell receives a data signal through the data lines (D1,D2 . . . Dm) and a scan signal through the scan lines (S1,S2, . . . Sn) and adjusts a liquid crystal alignment of the liquid crystal cell to pass or suppress light, thereby to display an image. The pixel unit 100 is divided into a plurality of blocks, and may receive a separate light source to each block to display an image. Also, blocks that display a bright image receive light from a bright light source, and blocks that display a dark image receive light from a dark light source, and therefore the pixel unit 100 may adjust a dark region and a bright region to a respective brightness in one screen.

The data driver 200 is coupled to a plurality of data lines (D1,D2 . . . Dm), and may transmit a data signal to a plurality of the data lines (D1,D2 . . . Dm) and allow a plurality of the data lines (D1,D2 . . . Dm) to transmit the data signal to pixels 101.

The scan driver 300 is coupled to a plurality of scan lines (S1,S2, . . . Sn), and may transmit a scan signal to a plurality of the scan lines (S1,S2, . . . Sn) and allow a plurality of the scan lines (S1,S2, . . . Sn) to transmit a data signal to the pixels 101 selected by the scan signal.

The back light unit 400 may generate light and transmit the generated light to the pixel unit 100. The pixel unit 100 may display an image by passing or suppressing the light, generated in the back light unit 400, in each of the liquid crystal cells. The back light unit 400 may be configured with an electron emission display device including a plurality of electron emission devices as shown in FIG. 2. A plurality of the electron emission devices may be used as a plurality of light sources, and each of the light sources corresponds to one or more blocks at the pixel unit 100.

The back light unit 400 may adjust the entire luminance to correspond to the luminance with which the pixel unit 100 emits the light during one frame period. That is, if pixels that represent a high luminance are present in large numbers in the pixel unit 100 during one frame period, then the back light unit 400 is allowed to emit light with a lower luminance than a set (or predetermined) luminance, and if pixels that represent a low luminance are present in large numbers in the pixel unit 100 during one frame period, then the back light unit 400 is allowed to emit light with a higher luminance than a set (or predetermined) luminance. Accordingly, if the pixel unit 100 emits light with a high luminance, a luminance of the back light unit 400 is lowered to maintain a luminance to be represented to a certain level, thereby preventing glare. Also, if the pixel unit 100 emits light with a low luminance, then a luminance of the back light unit 400 is increased to a certain level to enhance its contrast ratio, thereby improving visibility. Further, if the pixel unit 100 emits the light with a high luminance, power consumption may be reduced by lowering its luminance to a certain level.

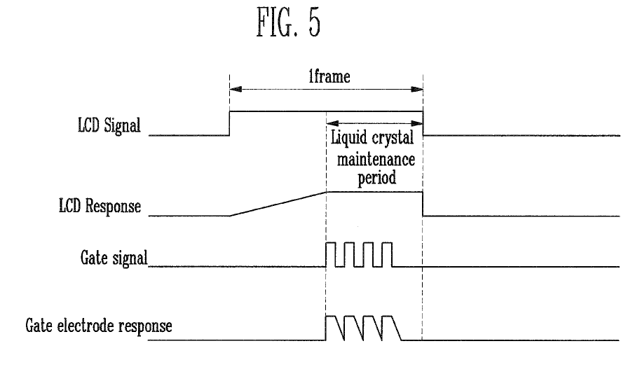

FIG. 4 is a waveform view showing a concept that light is emitted from the electron emission display device according to an exemplary embodiment of the present invention. Referring to FIG. 4, a signal delay is caused by a resistor component and a capacitor component present in the light source unit even if a substantially square waveform is transmitted to a cathode electrode or a gate electrode as shown in “Pa” of FIG. 4. As a result, a signal is applied to the cathode electrode or the gate electrode for a longer period than a period that an input signal is applied to the cathode electrode or the gate electrode due to a rising time and a falling time as shown in “Pb” of FIG. 4. Accordingly, the electron emission display device according to an exemplary embodiment uses a principle that an inputted signal has an increased falling time due to a resistor component and a capacitor component, and therefore because a signal is still transmitted to the cathode electrode or the gate electrode during the falling time, the electron emission display device still emits light by continuously emitting electrons. That is, a period that a voltage is applied to the cathode electrode or the gate electrode can be shorter by utilizing the falling time of a plurality of pulses that are transmitted than when one pulse is transmitted during a light emission time, and a period that electrons collide with the phosphor can also be shortened, and therefore damage to the cathode electrode, gate electrode, and the anode electrode may be reduced, which leads to an extended life span.

FIG. 5 is a waveform view showing a waveform of a signal inputted to the liquid crystal display (LCD) according to an exemplary embodiment of the present invention. The LCD signal represents a signal that is applied to liquid crystal cells. The LCD response represents a time that the liquid crystal cells respond to represent gray levels. The gate signal represents a waveform of a gate signal outputted from a gate driver. The gate response represents a waveform where a gate signal outputted from a gate driver is transmitted to a gate electrode.

Referring to FIG. 5, a data signal and the like are applied to liquid crystal cells during one frame period. However, the liquid crystal cells change a liquid crystal alignment to correspond to the applied signal, and in this case a set (or predetermined) time is required. Accordingly, the set (or predetermined) time when liquid crystals are maintained in a certain alignment is part of or a subset of one frame period (one vertical synchronization period). For example, the subset of one frame period may be the liquid crystal maintenance period as depicted in FIG. 5. If a gate signal is outputted in a plurality of pulse waveforms while the liquid crystals are maintained in a certain alignment in the electron emission display device, which is used as a back light unit of the liquid crystal display, then a signal transmitted to the electrode is delayed to increase a period that a signal is applied to a gate electrode, as shown in FIG. 4. If the signal is transmitted to the gate electrode, the electron emission display device emits electrons due to the voltage difference between the gate electrode and the cathode electrode, which leads to the light emission time to be continuous.

Also, if a voltage of the gate signal outputted from the gate driver is adjusted to correspond to a level of the image signal, the electron emission display device may represent grey levels using the back light unit.

According to the electron emission display device of an exemplary embodiment of the present invention and the liquid crystal display using the same, the electron emission display device may be used as the back light unit of the liquid crystal display, and its luminous efficiency is improved and a life span of an emitter is extended since heat generated is decreased in the anode electrode and/or gate electrode and/or cathode electrode of the electron emission display device. Also, it is possible to represent grey levels by utilizing the back light unit of the liquid crystal display.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electron emission display device, comprising:
a light source unit including a plurality of cathode electrodes and a plurality of gate electrodes crossing the plurality of cathode electrodes, the light source unit for emitting electrons corresponding to voltages of the gate electrodes and the cathode electrodes and allowing the emitted electrons to collide with a phosphor on an anode electrode to emit light;
a gate driver for generating a gate signal and transmitting the gate signal to at least one of the gate electrodes; and
a cathode driver for generating a cathode driving signal corresponding to an image signal and transmitting the cathode driving signal to at least one of the cathode electrodes,
wherein the cathode driving signal is transmitted in a plurality of pulse waveforms within one vertical synchronization period.

2. The electron emission display device according to claim 1, wherein a voltage of the pulse waveforms is adjusted to correspond to the image signal.

3. The electron emission display device according to claim 1, wherein the light source unit is adapted to adjust grey levels of the image signal to correspond to a pulse width of the cathode driving signal.

4. An electron emission display device, comprising:
a light source unit including a plurality of cathode electrodes and a plurality of gate electrodes crossing the plurality of cathode electrodes, the light source unit for emitting electrons corresponding to voltages of the gate electrodes and the cathode electrodes and allowing the emitted electrons to collide with a phosphor on an anode electrode to emit light;
a gate driver for generating a gate signal and transmitting the gate signal to at least one of the gate electrodes; and
a cathode driver for generating a cathode driving signal corresponding to an image signal and transmitting the cathode driving signal to at least one of the cathode electrodes,
wherein the gate signal is transmitted in a plurality of pulse waveforms within one vertical synchronization period.

5. The electron emission display device according to claim 4, wherein a voltage of the pulse waveforms is adjusted to correspond to the image signal.

6. The electron emission display device according to claim 4, wherein the light source unit is adapted to adjust grey levels of the image signal to correspond to a pulse width of the gate signal.

7. A liquid crystal display, comprising:
a pixel unit including a plurality of liquid crystal cells and for displaying an image by selectively passing or suppressing light of a light source by utilizing a data signal and a scan signal;
a data driver for transmitting the data signal to the pixel unit;
a scan driver for transmitting the scan signal to the pixel unit; and
a back light unit for transmitting light from the light source to the pixel unit,
wherein the back light unit comprises:
a light source unit including a plurality of cathode electrodes and a plurality of gate electrodes crossing the plurality of cathode electrodes, the light source unit for emitting electrons corresponding to voltages of the gate electrodes and the cathode electrodes and allowing the emitted electrons to collide with an anode electrode to emit the light;
a gate driver for generating a gate signal and transmitting the gate signal to at least one of the gate electrodes; and
a cathode driver for generating a cathode driving signal corresponding to an image signal and transmitting the cathode driving signal to at least one of the cathode electrodes,
wherein the cathode driving signal is transmitted in a plurality of pulse waveforms within one vertical synchronization period.

8. The liquid crystal display according to claim 7, wherein a voltage of the pulse waveforms is adjusted to correspond to the image signal.

9. The liquid crystal display according to claim 7, wherein the light source unit is adapted to adjust grey levels of the image signal to correspond to a pulse width of the cathode driving signal.

10. The liquid crystal display according to claim 7, wherein the cathode driving signal is transmitted during a subset of the vertical synchronization period.

11. A liquid crystal display, comprising:
a pixel unit including a plurality of liquid crystal cells and for displaying an image by selectively passing or suppressing light of a light source by utilizing a data signal and a scan signal;
a data driver for transmitting the data signal to the pixel unit;
a scan driver for transmitting the scan signal to the pixel unit; and
a back light unit for transmitting light from the light source to the pixel unit,
wherein the back light unit comprises:
a light source unit including a plurality of cathode electrodes and a plurality of gate electrodes crossing the plurality of cathode electrodes, the light source unit for emitting electrons to correspond to voltages of the gate electrodes and the cathode electrodes and allowing the emitted electrons to collide with a phosphor on an anode electrode to emit the light;
a gate driver for generating a gate signal and transmitting the gate signal to at least one of the gate electrodes; and
a cathode driver for generating a cathode driving signal corresponding to an image signal and transmitting the cathode driving signal to the cathode electrode,
wherein the gate signal is transmitted in a plurality of pulse waveforms within one vertical synchronization period.

12. A method for driving a liquid crystal display that displays an image by adjusting transmissivity of light of a light source for liquid crystal cells by utilizing a data signal and a scan signal, the method comprising:
transmitting the scan signal and the data signal to at least one of the liquid crystal cells to maintain the data signal during one frame period; and
transmitting light from the light source, generated in a back light unit, in a plurality of pulse waveforms for a subset of one frame period when the at least one of the liquid crystal cells are maintained to an active level.

13. The method for driving a liquid crystal display according to claim 10, wherein the back light unit adjusts luminance of the light source by utilizing pulse width modulation.
